(19) United States
(12) Patent Application Publication
(10) Pub. No.: US 2009/0023420 A1
(43) Pub. Date: Jan. 22, 2009

(54) METHOD FOR DISTRIBUTING EMERGENCY INFORMATION IN A TELECOMMUNICATIONS SYSTEM

(76) Inventor: Micael Martell, Kungsbacka (SE)

Correspondence Address: ERICSSON INC., 6300 LEGACY DRIVE, M/S EVR 1-C-11, PLANO, TX, 75024, US

(21) Appl. No.: 12/281,948

(22) PCT Filed: Mar. 9, 2006
(86) PCT No.: PCT/SE06/00299

§ 371 Date: Sep. 5, 2008

(51) Int. Cl. H04M 11/04

(52) U.S. Cl. 455/404.1

(57) ABSTRACT

The invention discloses a method for distributing emergency information to subscribers in a telecommunications system. According to the method, information is distributed via an existing protocol for distributing text messages and/or graphic messages within said system, and the information is distributed at points in time when the system load for distributing messages within said protocol falls below a certain predetermined level. Suitably, one and the same subscriber or group of subscribers is distributed in portions at said points in time, and said information can be distributed only to selected groups of subscribers.

### TECHNICAL FIELD

The present information discloses a method for distributing emergency information to subscribers in a telecommunications system, according to which method the information is distributed via an existing protocol for distributing text messages and/or graphic messages within said system

### BACKGROUND ART

At present, information to be used in the event of an emergency situation is distributed in a variety of ways. One such way is in the form of printed material, e.g. leaflets or, in some countries, in certain sections of phone books etc. An obvious drawback to such systems is that they are difficult and cumbersome to update. Also, they might not be at hand when an emergency situation occurs.

Another method which has been proposed recently is to use cellular telephony systems for distributing emergency information, when and if an emergency occurs. A drawback to this solution is that in the event of an emergency, the cellular system might not be functional, or might at least be severely degraded in its function. One possible cause for the degrading of the system is that in the event of an emergency, the system will be blocked due to the large amount of users trying to avail themselves of the system.

### DISCLOSURE OF THE INVENTION

As shown above, there is thus a need for a method by means of which information for use in emergency systems can be distributed to users in a way which will enable the information to be updated in a simpler way than previously, and which will also enable users to access the information more easily than previously. In addition to this, the method should also be functional in the event of an emergency.

These needs are addressed by the current invention in that it discloses a method for distributing emergency information to subscribers in a telecommunications system. According to the method of the invention, the information is distributed via an existing protocol for distributing text messages and/or graphic messages within said system, and the information is distributed at points in time when the system load for distributing messages within said protocol falls below a certain predetermined level.

As an alternative, the information can be distributed at predetermined points in time, irrespective of whether or not an event has occurred during which the information will be utilized.

In one embodiment of the invention, said information is distributed in portions at said points in time to one and the same subscriber or group of subscribers.

Thus, by means of the present invention, for example, so called SMS or MMS messages can be used by the system in order to distribute information for use in emergency situations. The information need not be distributed when an emergency occurs, but can be distributed at regular and, preferably, rather sparse intervals. Also, since the information need not be distributed in direct connection to the occurrence of an emergency, the information can be distributed at points in time when the load on the system is low, such as at night, for example.

Also, the information can be distributed in “snippets”, i.e. the information can be divided Pinto portions, which are then distributed to the users at different points in time, when the load on the system is low, if all of the information cannot be distributed at one and the same time.

By means of the invention, and due to the high degree of penetration of cellular telephony, a large amount of users will have the information available in their handsets, and thus at hand in the event of an emergency, even if the cellular system is down due to the emergency, or, for example, if there has been a power failure.

### BRIEF DESCRIPTION OF THE DRAWING

The invention will be described in more detail in the following description, with reference to the appended drawing, in which:

FIG. 1 shows a schematic overview of a system in which the invention is applied.

### EMBODIMENTS OF THE INVENTION

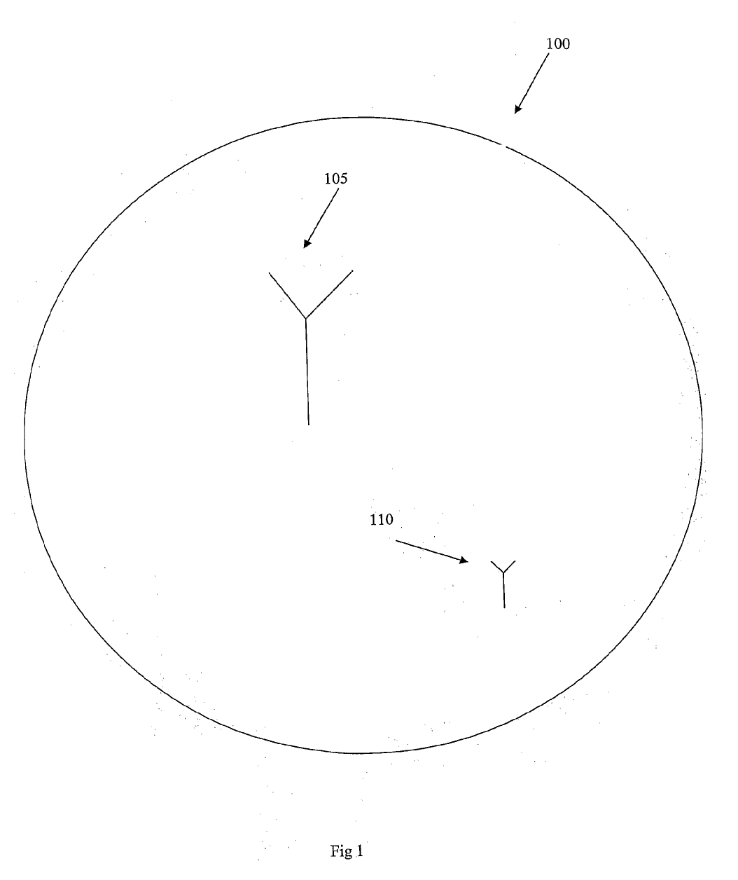

FIG. 1 shows a schematic overview of, a system 100 within which the present invention is applied.

The system 100 is a system for wireless cellular telephony, and can be any such system which as the ability to transmit text messages (usually known as SMS messages) and/or graphic messages (usually known as MMS messages) to users in the system. Thus, the system 100 can be a so called 2G or a so called 3G system, and can use either the CDMA or TDMA principle, or a combination of those principles.

Within the geographical area covered by the system 100, there is a number of base stations 105, and a number of users 110, each having at least one User Equipment (UE), usually but not necessarily in the form of a cellular telephone. Examples of other UE:s include PDA:s, portable computers with wireless LAN functions, etc. Each base station 105 handles all communication to and from the users 110 in a sub-area of the area covered by the system 100.

The invention will be described below with the aid of a number of non-limiting examples.

In a first example, the method of the invention is used to distribute information for use in an emergency situation to the inhabitants of a certain area. Said area can be an entire country, or a smaller area, so that the information can be tailored to events which are more likely to occur within said certain area. Examples of such areas are areas which include chemical factories, power plants, etc.

The information to be distributed within the area is rather static, i.e. it does not need to be updated more than a few times per year, typically only once a year.

According to the invention, in this example the information is distributed via an existing protocol for distributing text messages and/or graphic messages within the system, such as SMS or MMS or the like. Due to the fact that the information only needs to be updated at sparse intervals, the system can distribute the information at points in time when the load on the system for distributing SMS or MMS-messages is low. Typical examples of such points in time are at night, perhaps around or after midnight local time. The information would then be distributed when the system load for distributing such messages within the protocol for SMS or MMS, whichever may be the case, falls below a certain predetermined level.

If permitted by the system, the information can even be distributed in the form of special SMS/MMS-messages within the system, such as so called V-cards.

Also, since the distribution of the information is not time-critical, the information to one and the same subscriber or group of subscribers can be distributed in portions at said points in time, if, for example, the system load caused by other tasks increases while the information is being distributed.

Thus, for the users within the area in the example, the information will be updated without any active measures from said users. Another benefit of the invention is that a user who has his place of residence within the area in the example can have his information updated even if he is not with the area at the time.

In a second example of the invention, the information is distributed only to selected groups of subscribers, preferably within a chosen area. Assume, for example, that there has been a major accident, e.g. a plane crash or a severe traffic accident. The system might then, according to the invention, be used to distribute necessary information to all medical personnel within a certain radius of the accident. Thus, medical personnel entering the radius would also receive the information. Examples of such information include: the number of casualties, type of injuries, locations of hospitals that need assistance, accident sites where medical personnel is needed, etc.

The information as to which users are medical personnel, and perhaps sub-groups within that group, e.g. nurses, physicians, medics, etc can be obtained in a number of ways. In a preferred embodiment of the invention, a user who registers with the system in, an initial phase, e.g. upon buying his cellular telephone or registering for a subscription with the operator of the system, will also inform the operator of his belonging to any such special group, i.e. physicians, nurses, fire fighters, police officers etc.

Other examples of obtaining knowledge of the user's group belonging include the user-giving the system such information upon finding out that there has been an, emergency event in the area which he has entered or is about to enter. Thus, for example, physicians who happen to be travelling through an airport where there has been an accident can notify the system of their presence, and can in return receive emergency information which will allow them to assist local medical personnel.

Naturally, in the latter type of situations, it might not be feasible to delay transmitting the information until midnight or other points in time when the traffic load on the system is at or below the previously mentioned predetermined level. One solution to this is to alter the level for cases in which the information needs to be transmitted rapidly, and another solution to the same problem might be to give priority to the emergency information, i.e. lowering the priority for other users in order to let the emergency information be transmitted.

Naturally, the implementations of the invention described above can be combined in a desired manner. For example, the updating at sparse intervals might be applied to certain professions, so that, for example, medical personnel who have their place of residence within a certain area receive updated information at sparse intervals, a few times per year, said information pertaining to medical facilities within the area, or even to their own individual roles in the event of a major accident.

Thus, by means of the invention, a number of significant advantages are obtained, among which the following can be mentioned:
Emergency information is distributed that will be readily at hand, due to the high degree of penetration of cellular telephony. The information will be available even in the event of a power outage, which might occur if there is a major disaster such as, for example, an earthquake. The information will be at hand as long as the battery of the user's cellular telephones last, usually be at least a few hours, which could very well correspond to the time necessary to get the power operational again.
Since the information can be distributed before an emergency has occurred, the information will be available even if the system as such is not operational.
The information can be tailored to selected groups of users, according to place of residence, profession, etc.
The information can be updated at intervals chosen by the operator of the system, or by the authorities distributing the information.
The distribution of information does not, in most cases, place a high load on the system, since it is distributed at sparse intervals, and at times when there is a low level of other traffic.
The usage of cellular telephony is likely to grow in the future. Thus, the invention will keep on acquiring an even higher degree of applicability.

1.-9. (canceled)

10. A method for distributing emergency information to subscribers in a telecommunications system, according to which method the emergency information is distributed via an existing protocol for distributing text messages and/or graphic messages within said system, said method comprising the step of:
distributing, by the system, the emergency information at points in time when the system load for distributing messages within said protocol falls below a certain predetermined level.

11. The method of claim 10, wherein the system distributes said emergency information to one and the same subscriber or group of subscribers in portions at said points in time.

12. The method of claim 10, wherein said emergency information is distributed by the system only to selected groups of subscribers.

13. The method of claim 12, wherein the system distributes the emergency information to said selected group of subscribers who have registered as belonging to said group in advance.

14. The method of claim 12, wherein the system distributes the emergency information to said selected group of subscribers who have registered upon being notified of an event in which they desire to receive said information.

15. The method of claim 12, wherein the system distributes the emergency information to said selected group of subscribers who are located within a given geographical area at a given point in time.

16. The method of claim 12, wherein the system distributes the emergency information to said selected group of subscribers who have their place of residence within a given geographical area at a given point in time.

17. The method of claims 10, wherein the system prioritizes the distribution of said emergency information within said protocol by shutting off or down-prioritizing other traffic within the system.

18. A method for distributing emergency information to subscribers in a telecommunications system, whereby the system distributes the emergency information via an existing protocol for distributing text messages and/or graphic messages within said system, said method comprising the step of:
distributing, by the system, the emergency information at predetermined points in time, irrespective of whether or not an event has occurred during which the emergency information will be utilized.

19. The method of claim 18, wherein the system distributes said emergency information to one and the same subscriber or group of subscribers in portions at said points in time.

20. The method of claim 18, wherein said emergency information is distributed by the system only to selected groups of subscribers.

21. The method of claim 20, wherein the system distributes the emergency information to said selected group of subscribers who have registered as belonging to said group in advance.

22. The method of claim 20, wherein the system distributes the emergency information to said selected group of subscribers who have registered upon being notified of an event in which they desire to receive said information.

23. The method of claim 20, wherein the system distributes the emergency information to said selected group of subscribers who are located within a given geographical area at a given point in time.

24. The method of claim 20, wherein the system distributes the emergency information to said selected group of subscribers who have their place of residence within a given geographical area at a given point in time.

25. The method of claims 18, wherein the system prioritizes the distribution of said emergency information within said protocol by shutting off or down-prioritizing other traffic within the system.

26. A node in a telecommunications system for distributing emergency information to subscribers, said node adapted to distribute the emergency information via an existing protocol for distributing text messages and/or graphic messages within said system, said node comprising:
means for distributing the emergency information at points in time when the system load for distributing messages within said protocol falls below a certain predetermined level.

27. The node of claim 26, further comprising means for distributing said emergency information to one and the same subscriber or group of subscribers in portions at said points in time.

28. The node of claim 26, further comprising means for distributing said emergency information by the system only to selected groups of subscribers.

29. The node of claim 28, further comprising means for distributing the emergency information to said selected group of subscribers who have registered as belonging to said group in advance.

30. The node of claim 28, further comprising means for distributing the emergency information to said selected group of subscribers who have registered upon being notified of an event in which they desire to receive said information.

31. The node of claim 28, further comprising means for distributing the emergency information to said selected group of subscribers who are located within a given geographical area at a given point in time.

32. The node of claim 28, further comprising means for distributing the emergency information to said selected group of subscribers who have their place of residence within a given geographical area at a given point in time.

33. The method of claims 26, further comprising means for prioritizing said emergency information within said protocol by shutting off or down-prioritizing other traffic within the system.
